(19) United States
(12) Patent Application Publication
(10) Pub. No.: US 2026/0030982 A1
(43) Pub. Date: Jan. 29, 2026

(54) DISPLAY CONTROL DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/065,115

(22) Filed: Feb. 27, 2025

(30) Foreign Application Priority Data
Jul. 25, 2024 (JP) 2024-120347

(51) Int. Cl. G08G 1/0967; G08G 1/0968

(52) U.S. Cl. CPC G08G 1/0967; G08G 1/096855

(57) ABSTRACT

The display control device includes a display control unit that displays, on a display unit provided around a driver's seat of the host vehicle, a host vehicle image imitating the host vehicle and a lane image imitating a lane on which the host vehicle can travel, and displays, in a different manner, a first region including the lane image indicating a recommended lane on which the host vehicle is recommended to travel among the lanes, and a second region including the lane image indicating the lane other than the recommended lane.

### CROSS-REFERENCE TO RELATED APPLICATION

This application claims priority to Japanese Patent Application No. 2024-120347 filed on Jul. 25, 2024. The disclosure of the above-identified application, including the specification, drawings, and claims, is incorporated by reference herein in its entirety.

### BACKGROUND

### 1. Technical Field

The present disclosure relates to a display control device.

### 2. Description of Related Art

Japanese Patent No. 7048398 (JP 7048398 B) discloses a vehicle control device capable of performing autonomous driving that gives a sense of security to an occupant.

### SUMMARY

In the technique according to JP 7048398 B, an image indicating the host vehicle, an image indicating the surrounding situation of the host vehicle, and the like are displayed on a display unit (see FIG. 8 of JP 7048398 B). However, conventional navigation has not been able to sufficiently present a lane in which travel is recommended.

An object of the present disclosure is to provide a display control device that allows grasping a lane in which travel is recommended.

A first aspect of the present disclosure provides a display control device including a display control unit that displays, on a display unit provided around a driver's seat of a host vehicle, a host vehicle image simulating the host vehicle and a lane image simulating lanes in which the host vehicle is allowed to travel, and that displays a first region and a second region in different manners, the first region including the lane image indicating a recommended lane in which the host vehicle is recommended to travel, among the lanes, and the second region including the lane image indicating the lanes other than the recommended lane.

The display control device according to the first aspect of the present disclosure allows grasping a lane in which travel is recommended.

In the display control device according to the first aspect of the present disclosure, the display control unit may display a route image indicating a travel route of the host vehicle that is displayed in a changed manner based on a travel mode of the host vehicle. According to the display control device of the first aspect of the present disclosure, it is possible to allow grasping a lane and a route on which travel according to the travel mode is recommended.

In the display control device according to the first aspect of the present disclosure, the display control unit may display a different vehicle image simulating a different vehicle on the lanes in the first region and the second region, and displays the different vehicle image in a changed manner according to an amount of congestion information for each of the lanes. According to the display control device of the first aspect of the present disclosure, it is possible to allow grasping a lane in which travel is recommended according to congestion.

In the display control device according to the first aspect of the present disclosure, the display control unit may display the different vehicle image in the first region and the different vehicle image in the second region in different manners. According to the display control device of the first aspect of the present disclosure, it is possible to allow grasping a lane in which travel is recommended according to the difference in the manner of the different vehicles.

According to the technique of the present disclosure, it is possible to control the display mode of a lane in which travel is recommended.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a first display example displayed on a monitor;

FIG. 3A is a second exemplary display in which the driving mode is displayed on the monitor in the default mode;

FIG. 3B is a second exemplary display in which a driving mode is displayed on a monitor in a sporting mode;

FIG. 4 is a third exemplary display displayed on a monitor; and

FIG. 5 is a flowchart illustrating a flow of the specifying process.

### DETAILED DESCRIPTION OF EMBODIMENTS

Hereinafter, the vehicle 10 according to the present embodiment will be described.

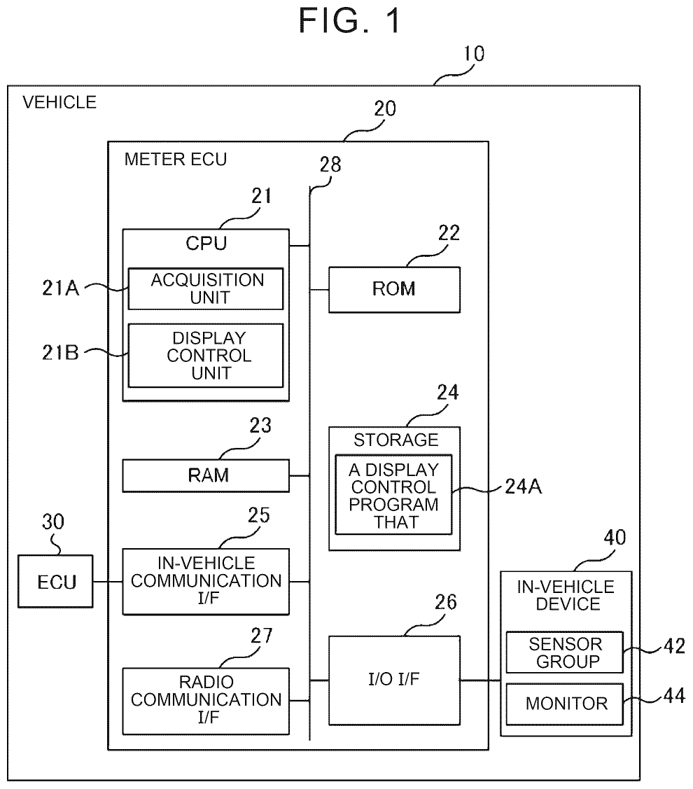

FIG. 1 is a block diagram illustrating a hardware configuration of a vehicle 10. As illustrated in FIG. 1, the vehicles 10 include a meter ECU (Electronic Control Unit) 20. The vehicle 10 is an example of a “vehicle” of the present disclosure, and the meter ECU 20 is an example of a “display control device” of the present disclosure.

The meter ECU 20 includes CPU (Central Processing Unit) 21, ROM (Read Only Memory) 22, RAM (Random Access Memory) 23, storage 24, in-vehicle communication I/F (Inter Face) 25, input/output I/F 26, and wireless communication I/F 27. CPU 21, ROM 22, RAM 23, the storage 24, the in-vehicle communication I/F 25, the input/output I/F 26, and the wireless communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

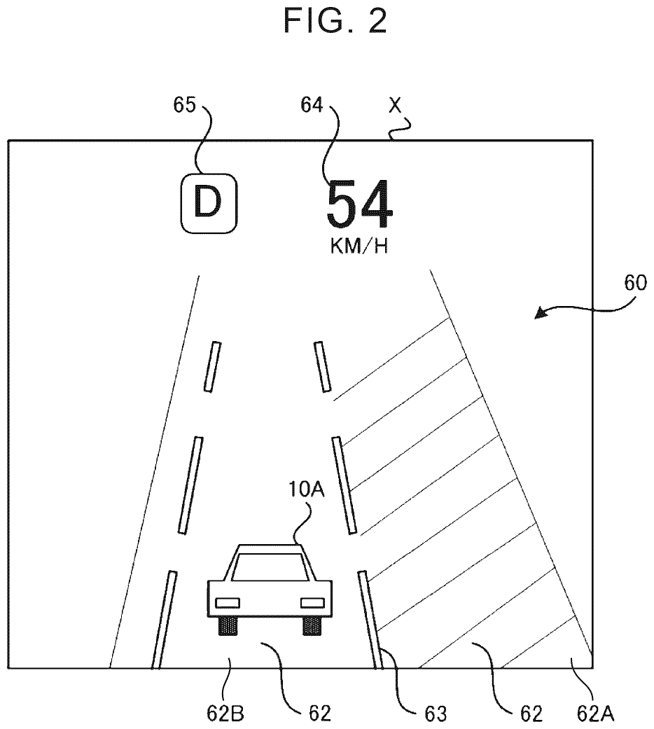

The storage 24 is constituted by a storage device such as an eMMC (embedded Multi Media Card) or a UFS (Universal Flash Storage), and stores various programs and various data. The storage 24 stores a display-control-program 24A. The display control program 24A is a program for causing CPU 21 to execute a specifying process (see FIG. 2) to be described later.

The in-vehicle communication I/F 25 is an interface for connecting to another ECU 30. The interface uses a CAN protocol-based communication standard. The in-vehicle communication I/F 25 is connected to an external bus 29. Although not shown, a plurality of ECU is provided for each function of the vehicles 10 in addition to ECU 30. ECU 30 of the present embodiment has a function of determining a recommended lane and a recommended route.

The input/output I/F 26 is an interface for communicating with the in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes, for example, a 3D-LiDAR, a millimeter-wave sensor, an infrared sensor, a winker sensor, an accelerator position sensor, a vehicle speed sensor, a steering angle sensor, an angular velocity sensor, a GPS (Global Positioning System sensor), an illuminance sensor, and a gyro sensor. The sensor group 42 includes, for example, a sensor for detecting a state of the vehicle 10, such as an acceleration sensor, and a state around the vehicle 10, and a plurality of cameras for imaging the periphery of the vehicle 10. The sensor group 42 outputs a detection result of each sensor and an image captured by each camera to the meter ECU 20, ECU 30, and the like.

The monitor 44 is a meter display provided on a meter panel disposed in front of the driver's seat of the vehicle 10 and for displaying an operation proposal related to the function of the vehicle 10, an image related to the explanation of the function, and the like. The monitor 44 is an example of a “display unit” of the present disclosure. Note that the monitor 44 is not limited to the meter panel in front of the driver's seat, and may be provided around the driver's seat.

The wireless communication I/F 27 is a wireless communication module for communicating with an external device. As the radio communication module, for example, communication standards such as 5G, LTE, Wi-Fi (registered trademark) and Bluetooth (registered trademark) are used.

Further, CPU 21 of the meter ECU 20 has, as a functional configuration, an acquiring unit 21A and a display control unit 21B. The respective functional configurations are realized by CPU 21 reading and executing the display-control-program 24A stored in the storage 24.

The acquiring unit 21A acquires various types of data. For example, the acquiring unit 21A acquires, as various types of information, peripheral information around the vehicle 10 that can be detected by the vehicle 10. The peripheral information includes a detection result by each sensor constituting the sensor group 42, a captured image by each camera, and the like.

The display control unit 21B performs display control related to the display of the monitor 44. For example, the display control unit 21B causes the display region X of the monitor 44 to display, as the display control, the host vehicle image 10A indicating the vehicle 10 when viewed from the virtual viewpoint and the lane image 62 imitating the lane on which the host vehicle can travel, based on the surrounding information acquired by the acquiring unit 21A (see FIG. 2 and the like). The virtual viewpoint is set on a three-dimensional virtual space whose origin is the position of the host vehicle image 10A, and is defined by viewpoint coordinates and viewpoint angles (orientations) on the virtual space. For example, the virtual viewpoint is a viewpoint viewed at a specific viewpoint angle from a specific viewpoint coordinate on the upper side of the host vehicle image 10A in the virtual space.

ECU 30 determines a recommended lane in which the vehicle is recommended to travel on the basis of the road condition. The road condition is position information, lane information, and congestion information of the vehicle surrounding the host vehicle.

ECU 30 determines a recommended route corresponding to the traveling mode. The traveling mode is, for example, a default mode, a sport mode, an eco mode, or the like. The default mode is a mode for traveling on a road such as a normal city. The sport mode is a mode in which the vehicle travels on a road such as a winding road, and the steering operation, acceleration/deceleration, and the like are controlled more slowly than in the normal mode. The eco mode is a mode in which the vehicle 10 travels while suppressing fuel consumption (including electric power consumption), and the steering operation, acceleration/deceleration, and the like are also controlled to suppress fuel consumption.

Further, the display control unit 21B causes the first region including the lane image indicating the recommended lane and the second region including the lane image indicating the lane other than the recommended lane to be displayed differently.

FIG. 2 is a diagram illustrating a first display example displayed on a monitor. As illustrated in FIG. 2, a host vehicle image 10A indicating the vehicle 10 is displayed. In addition, in the region X, a lane image 62 indicating the traveling lane of the vehicle 10 and a white line image 63 indicating the white line defining the traveling lane are displayed as peripheral images indicating the surrounding situation. Further, an image 64 indicating vehicle speed information of the vehicle 10 and an image 65 indicating a shift position of the vehicle 12 are displayed above the lane image 62.

Here, the lane images 62 display the first region 62A of the recommended lane and the second region 62B other than the recommended lane differently. The display of the first region 62A drawn by a diagonal line indicates that the display is rendered brighter than the display of the second region. Note that the display mode is not limited to the brightness, and the display mode may be changed by a color scheme, a shade, a pattern, or the like. Note that, in the example of FIG. 2, the recommended lane is the range of the first region 62A and the range of the equal lane, but the present disclosure is not limited thereto, and a part of the first region 62A may be drawn as the recommended lane. In addition, the first region 62A and the second region 62B may include not only a lane image but also a marking image of an image schematically showing another road surface marking and an obstacle image. Therefore, images included in these regions may be displayed in different display modes for each region.

In addition, the display control unit 21B draws route images indicating different recommended routes according to the traveling mode. The route image is changed and displayed based on the traveling mode of the host vehicle.

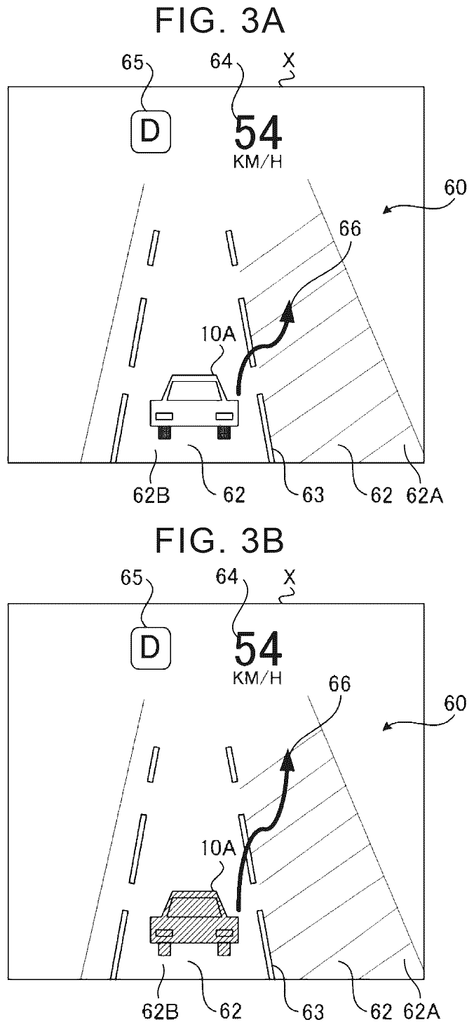

FIG. 3A and FIG. 3B are diagrams illustrating a second exemplary display displayed on the monitor. FIG. 3A shows the route images 66 when the driving mode is the default mode. FIG. 3B shows the route images 66 for the sporting mode. In addition, 10A of images of vehicles in the sporting mode is rendered brighter than in the default mode. In the sport mode, since the acceleration is controlled so as to be generated, the route image 66 of the path extending in the forward direction on the assumption of the acceleration is displayed rather than the default route image 66. This makes it possible to ascertain the degree of acceleration corresponding to the traveling mode. Further, the drawing of the road surface of the lane image 62 may be changed in accordance with the traveling mode. For example, in the case of the eco mode, an arrow in the reverse direction to the traveling direction may be drawn so as to be superimposed on the lane image 62, and may indicate that the control is slower than normal. In addition, in the sport mode, an arrow along the traveling direction may be drawn so as to be superimposed on the lane image 62 so as to represent a control that is easier to accelerate than usual.

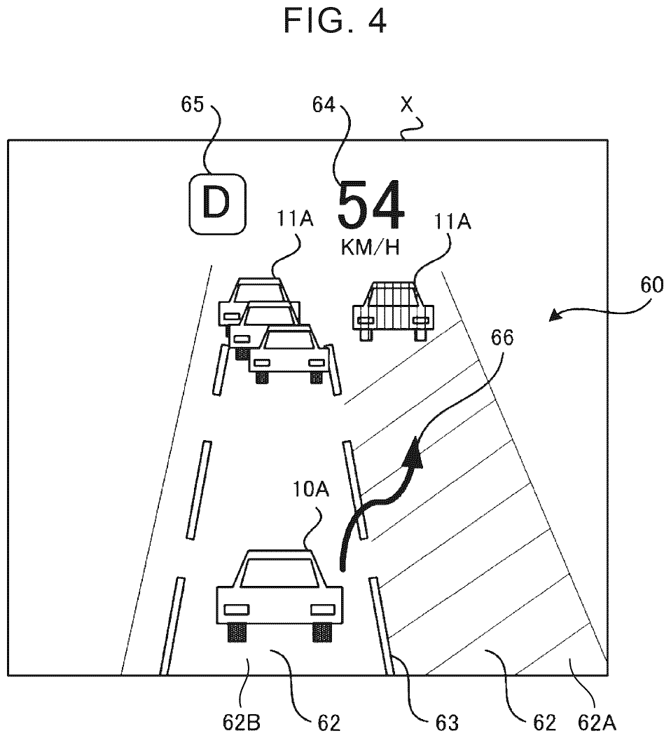

Further, the display control unit 21B displays the different vehicle image 11A simulating the different vehicle on the lanes of the first region 62A and the second region 62B, and changes the mode of the different vehicle image 11A according to the amounts of the congestion information of the respective lanes to display the same. FIG. 4 is a diagram illustrating a third display example displayed on the monitor. In addition, the different vehicle image 11A of the first region 62A and the different vehicle image 11A of the second region 62B are displayed differently. For example, the different vehicle images 11A of the first region 62A are displayed so as to blink. Further, the brightness, the shape, and the like may be made different from each other.

### Control Flow

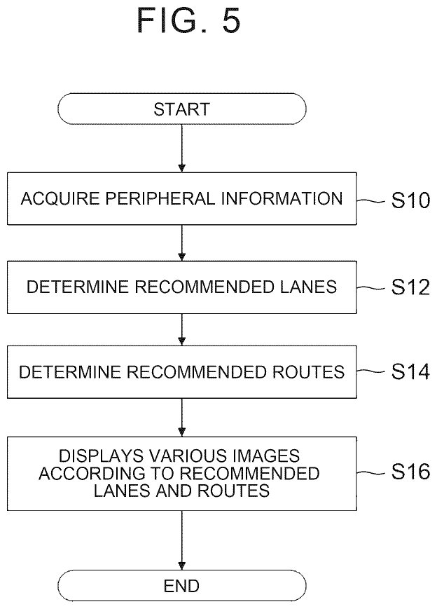

FIG. 5 is a flow chart illustrating a flow of a specifying process executed by the meter ECU 20. CPU 21 reads the display-control-program 24A from the storage 24, develops it in RAM 23, and executes it, thereby performing the specifying process. As an example, the identification processing is performed repeatedly and automatically every time a certain period of time elapses.

In S10, CPU 21 acquires peripheral information that can be detected by the vehicles 10. Then, CPU 51 proceeds to S12.

In S12, ECU 30 determines a recommended lane in which the vehicle is recommended to travel based on the road condition.

In S14, ECU 30 determines a recommended route corresponding to the traveling mode.

In S16, CPU 21 displays various images corresponding to the recommended lane and the recommended route on the monitor 44. The various images draw an own-vehicle image 10A, a lane image 62, a route image 66 indicating a recommended route, and the like.

As described above, in the meter ECU 20 (display control device), CPU 21 displays various images corresponding to the recommended lane and the recommended route. As a result, the meter ECU 20 can recognize a lane in which travel is recommended.

Also, the recommended lane and the recommended route may be changed depending on the position and road conditions of the host vehicle and the different vehicles. For example, a white bike around the vehicle may determine the recommended lane and path to avoid without changing the lane. In addition, if the host vehicle is within the intersection, the recommended route may be determined so as to accelerate and escape from the intersection.

In the above embodiment, the monitor 44, which is a meter display, is an example of the “display unit” of the present disclosure, but the example of the “display unit” is not limited to the meter display. For example, an exemplary “display unit” may be other displays, such as a center display and a head-up display (HUD). An example of the “display unit” may be a combination of a plurality of displays such as a meter display and a center display.

In the above-described embodiment, the meter ECU 20 executes the specifying process illustrated in FIG. 5. However, the present disclosure is not limited thereto, and the specifying process may be executed by the meter ECU 20 and other ECU in cooperation with each other.

It should be noted that the identifying process executed by CPU 21 reading the software (program) in the above-described embodiment may be executed by various processors other than CPU. Examples of the processor include a PLD (Programmable Logic Device) in which a circuit configuration can be changed after manufacturing of FPGA (Field-Programmable Gate Array), and the like, and a dedicated electric circuit that is a processor having a circuit configuration designed exclusively for executing a particular process such as ASIC (Application Specific Integrated Circuit), and the like. Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above embodiment, the display control program 24A is stored (installed) in the storage 24 in advance, but the present disclosure is not limited thereto. The display-control-program 24A may be provided in a form recorded in a recording medium such as CD-ROM (Compact Disk Read Only Memory), DVD-ROM (Digital Versatile Disk Read Only Memory), and USB (Universal Serial Bus). In addition, the display-control-program 24A may be downloaded from an external device via a network. Note that the technology of the present disclosure can also be applied to programs and program products.

What is claimed is:

1. A display control device comprising a display control unit that displays, on a display unit provided around a driver's seat of a host vehicle, a host vehicle image simulating the host vehicle and a lane image simulating lanes in which the host vehicle is allowed to travel, and that displays a first region and a second region in different manners, the first region including the lane image indicating a recommended lane in which the host vehicle is recommended to travel, among the lanes, and the second region including the lane image indicating the lanes other than the recommended lane.

2. The display control device according to claim 1, wherein the display control unit displays a route image indicating a travel route of the host vehicle that is displayed in a changed manner based on a travel mode of the host vehicle.

3. The display control device according to claim 1, wherein the display control unit displays a different vehicle image simulating a different vehicle on the lanes in the first region and the second region, and displays the different vehicle image in a changed manner according to an amount of congestion information for each of the lanes.

4. The display control device according to claim 3, wherein the display control unit displays the different vehicle image in the first region and the different vehicle image in the second region in different manners.
